(19) United States
(12) Patent Application Publication
(10) Pub. No.: US 2012/0298317 A1
(43) Pub. Date: Nov. 29, 2012

(54) AUTOMATIC ROLL-UP DEVICE OF A VENETIAN BLIND

(76) Inventor: Hsien-Te HUANG, Taipei City (TW)

(21) Appl. No.: 13/238,797

(22) Filed: Sep. 21, 2011

(30) Foreign Application Priority Data
May 27, 2011 (TW) 100209698
Aug. 2, 2011 (TW) 100214273

(51) Int. Cl. E06B 9/32

(52) U.S. Cl. 160/170

(57) ABSTRACT

An automatic roll-up device is applied to a Venetian blind which rolls up laths by itself through a feedback action. The roll-up device uses specifically a single shaft tube, an interior of which provides axially for installation of a volute spring and which is driven directly by the volute spring. An outer circumference of the shaft tube links and rolls up lift cords directly to achieve a dual-functional roll-up effect in a limited and simple structure.

### BACKGROUND OF THE INVENTION

a) Field of the Invention

The present invention relates to an automatic roll-up device of a Venetian blind. The device is a simple design of structure wherein an outer circumference of a shaft tube is used directly to link and roll up lift cords so that a dual function can be achieved in a limited mechanism.

b) Description of the Prior Art

The blind implemented in the present invention is the blind with lift cords to roll up and down laths. The present invention discloses a roll-up device which can be applied to a roll-up blind without the lift cords to roll up by itself the shading laths, and thus is characterized in having a simple structure.

For a Venetian blind 1 that can roll up by itself and is with lift cords, an interior of a headrail 10 is provided with a device absorbing pull-down energy (as shown in FIG. 1). The interior of the headrail 10 is provided with a power storage device 101 with a spiral plate spring and the power storage device 101 drives by gnawing with gears a reel 102 which is inside the headrail 10 and can rotate horizontally. The reel 102 rolls up lift cords 11 which link laths 100 at a bottom and when the laths 100 are pulled down to shade from light, the lift cords 11 will drive the reel 102 to rotate clockwise. The energy of operation drives the power storage device 101 to absorb the pull-down power and compress the interior spiral plate spring, so that feedback energy can be stored inside the power storage device 101.

In this design, a lower end of the lath has to be provided with a counter weight, such as an iron plate, so that when the lower end of the lath 100 is at any height, the lath 100 can be fixed at that height.

In addition, due to the structure type, the capacity of absorbing the feedback energy is limited and if the lift cords are broken, they will be very difficult to repair. Besides, there is no way to adjust the existing elements when they are elastically fatigued after being used for a long time.

### SUMMARY OF THE INVENTION

The primary object of the present invention is to provide an automatic roll-up device of a Venetian blind, wherein a shaft-type feedback device is provided, with that an outer circumference of the feedback device links directly with a shaft tube. An outer circumference of the shaft tube forms directly a dual function; one is rolling and the other one is displacement along an axial direction. Moreover, a hollow passage inside the shaft tube provides sufficiently for installation of a volute spring that a large feedback force and a simple structure can be achieved.

According to the present invention, the outer circumference of the shaft tube drives in advance a winding device which can form a dual-functional roll-up operation.

According to the present invention, a radial limiting mechanism is provided between the feedback device and the shaft tube. The radial limiting mechanism can fix the lath at any height.

According to the present invention, the other end of the shaft tube can be guided to displace longitudinally by a bolt and the feedback device is extended with a slide bar which is slidingly and parallel provided on one end of the headrail, such that the shaft tube body can rotate radially to roll up the lift cords and can even displace axially, thereby achieving the dual-functional effect of rolling up the lift cords and simplifying the winding part.

According to the present invention, an interior at the other end of the shaft tube can be provided coaxially with an axial-type buffering device to form a damping change, so that when the energy of the feedback device is at maximum, a rate of power output can be buffered.

According to the present invention, a pivot of the feedback device can be tuned by an adjustment device to increase the feedback energy. In particular, a home user can adjust by oneself the feedback device when it is elastically fatigued after being used for a long time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a feedback mechanism of a conventional Venetian blind without lift cords.

FIG. 2 shows a cutaway view of an assembly relation of a feedback device of the present invention.

FIG. 3 shows an end view of the assembly relation of the feedback device of the present invention.

FIG. 4 shows a schematic view of a state of using a position-changing mechanism of the present invention.

FIG. 5 shows another schematic view of the state of using the position-changing mechanism of the present invention.

FIG. 6 shows a relation diagram of the present invention that implements an adjustment device.

FIG. 7 shows an internal structural diagram of the present invention that implements the adjustment device.

FIG. 8 shows a cutaway view of a structure of the present invention that implements a buffering device to interfere with a rotation speed of the shaft tube.

FIG. 9 shows a cutaway view of a structure of the present invention that implements a shaft tube able to displace transversally.

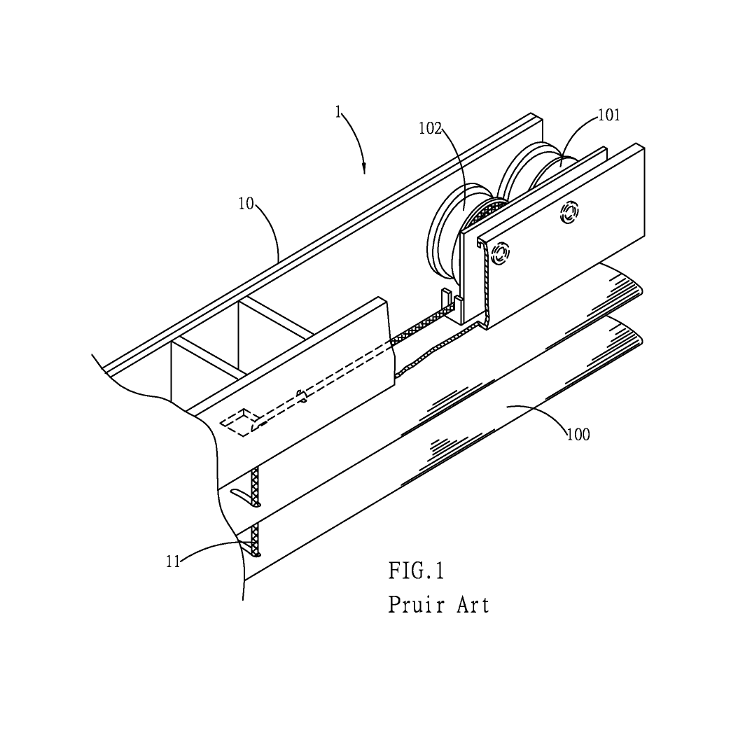

### DETAILED DESCRIPTION OF THE PREFERRED EMBODIMENTS

The Venetian blind provided by the present invention is a safe blind design without lift cords.

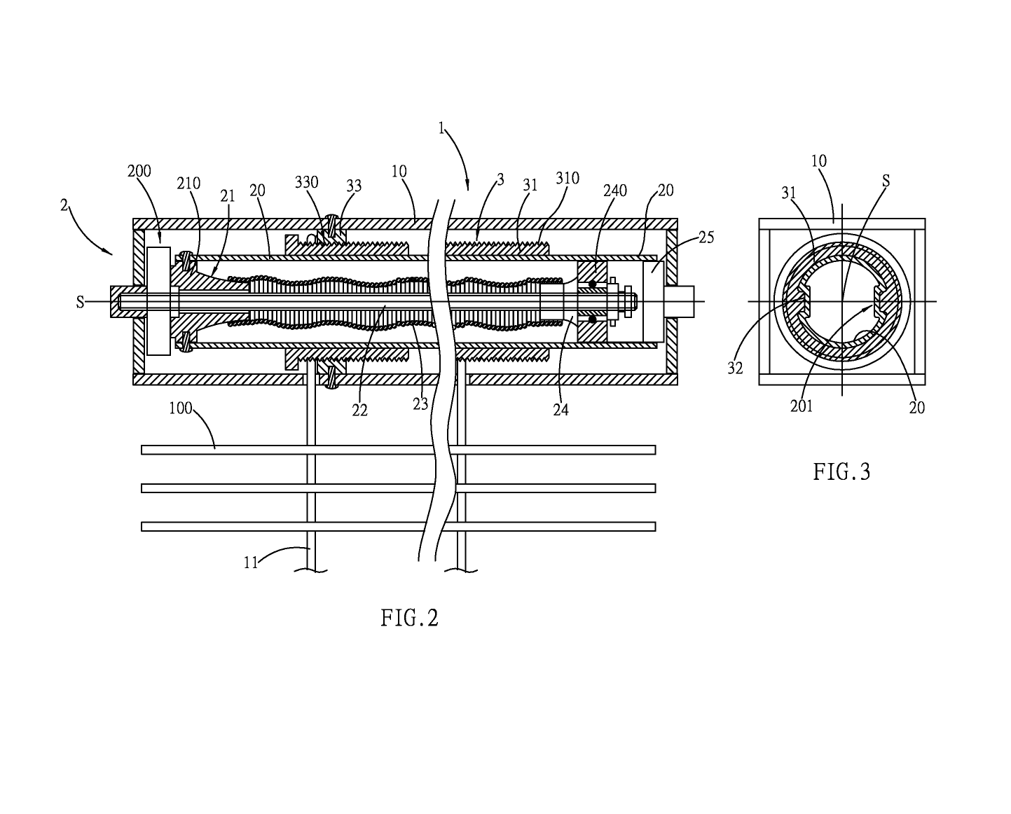

Referring to FIG. 2 and FIG. 3, the Venetian blind 1 provided by the present invention is provided with a headrail 10, an interior of which provides for axial installation of a feedback device 2. The feedback device 2 is an axial type and a pivot 22 which can be positioned radially connects each element longitudinally. An entire body of the feedback device 2 can be pivoted at a longitudinal space inside the headrail 10 and a hollow passage inside a shaft tube 20 can completely provide for installation of a volute spring 23 to store energy; more feedback energy can be accumulated as the amount of volute spring 23 increases.

An end of the feedback device 2 is interconnected with a radial limiting mechanism 200 which is used normally to fix at multiple angles a lath that is rolled back automatically. An axial center of the radial limiting mechanism 200 is overlapped with a working axis S of the feedback device 2 and is fixed at a corresponding side of the headrail 10. The radial limiting mechanism 200 is combined with the feedback device 2 by combining with a link ring 210 which is extended from a pier 21. During operation, the link ring 210 will drive the shaft tube 20 to rotate simultaneously and while at rest, the link ring 210 will be limited by the multi-angular positioning function of the radial limiting mechanism 200 and be positioned at a certain angle (as the radial limiting mechanism 200 is an ordinary limiting mechanism of centrifugal detachment, no further description is provided here), allowing a lower end of the lath 100 not to be fixed at any height when the lath 100 is pulled down.

An inner circumference of the pier 21 provides for movable penetration of the pivot 22 and a tail end (right end) of the pivot 22 is connected to a support element 24. The support element 24 and the pivot 22 are combined as a same unit and an inner end of the support element 24 is fixed by and assembled with an opening on an inner circumference at a corresponding end of the volute spring 23. On the other hand, on an outer circumference of the support element 24, an annular unit 240 is sheathed with an inner circumference at a corresponding end of the shaft tube 20 to form a movable coaxial relation. The pier 21 at a left end provides for fixing of a corresponding end of the volute spring 23 and an end of the volute spring 23 is combined at the pier 21 which can rotate freely. Under a condition that the other end of the volute spring 23 is fixed by the support element 24, when the shaft tube 20 rotates by an external force, opposite angles at two ends of the volute spring 23 will be distorted, allowing a change of elastic energy to be formed inside the volute spring 23 to accumulate the feedback energy. On the other hand, the feedback energy outputted by the volute spring 23 drives the connected shaft tube 20 through the pier 21, so that the shaft tube 20 can rotate reversely to roll back the lift cords 11.

An inner circumference at a right end of the shaft tube 20 provides for movable pivoting of the support element 24 through an inner circumference of the annular unit 240, allowing a right end of the pivot 22 to be pivoted at a center of the annular unit 240 by the support element 24. An opening at the right end of the shaft tube 20 is movably sheathed with a pivot seat 25, an axis of which is similarly overlapped with the working axis S.

The outer circumference of the shaft tube 20 links to a winding device 3 (as shown in FIG. 3) which is provided with a dual-functional operation mode which consists of radial rotation driven simultaneously by the rotation of the shaft tube 20 and axial displacement. The link relation is that an inner circumference of a roller 31 is provided with a slide block 32 and the shaft tube 20 is provided with a longitudinal slot 201 at a position relative to the slide block 32; whereas, the longitudinal slot 201 provides for sliding of the slide block 32 to form a longitudinal displacement. Besides, the longitudinal slot 201 can stop the radial link of the slide block 32. Therefore, the shaft tube 20 drives the roller 31 to rotate radially and simultaneously.

The winding device 3 includes the roller 31, a surface of which is provided with threads 310 which cut tangentially at a rotary-cut element 33 fixed on the headrail 10 and are cut by female threads 330. Therefore, when the roller 31 rotates radially by the link of the shaft tube 20, the threads 310 will be cut by the female threads 330 of the rotary-cut element 33 to result in the tangential cut, forming a left or right axial displacement to the roller 31 at a location relative to the rotary-cut element 33.

A root portion of the threads 310 provides for combination with an upper end of the lift cord 11. A distance of threads is principally the same as a diameter of the lift cord 11, and therefore, when the roller 31 winds by one turn, the lift cord 11 also winds at the outer circumference of the roller 31 by one turn. In addition, due to the rotary-cut action of the female threads 330 of the rotary-cut element 33, when the roller 31 winds by one turn, a yield of one distance of threads will be resulted to the threads 310 of the roller 31; therefore, the lift cord 11 will be wound on the surface of the roller 31 and is tidily arranged side by side in order, allowing the lift cord 11 not to be overlapped from top to bottom after winding.

The outer circumference of the shaft tube 20 can link longitudinally as a same unit with more than two winding devices 3 and each winding device 3 corresponds to one lift cord 11. Depending upon the quality and width of the lath, the amount of the winding device 3 can be flexibly allocated, which facilitates the adjustment of product specifications during manufacturing. For example, a wide and large lath will require more lift cords 11 and therefore, within the length of the shaft tube 20, plural winding devices can be allocated in advance to meet the requirement of many lift cords. The allocation is a simple operation of addition without the need for modifying the original structure, as long as that a lower part of the headrail 10 is provided with holes or slits for the penetration of the lift cords 11.

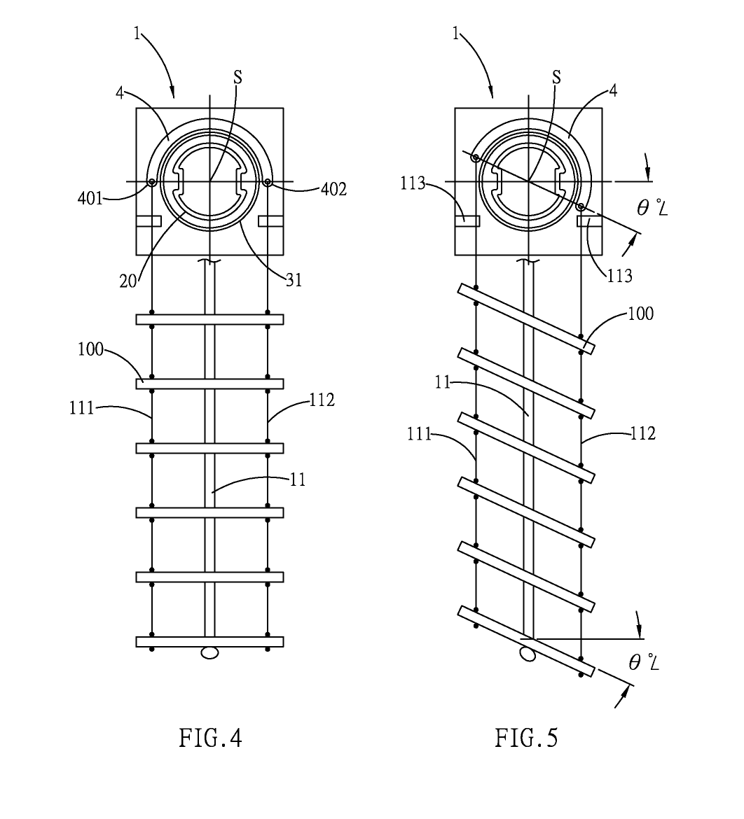

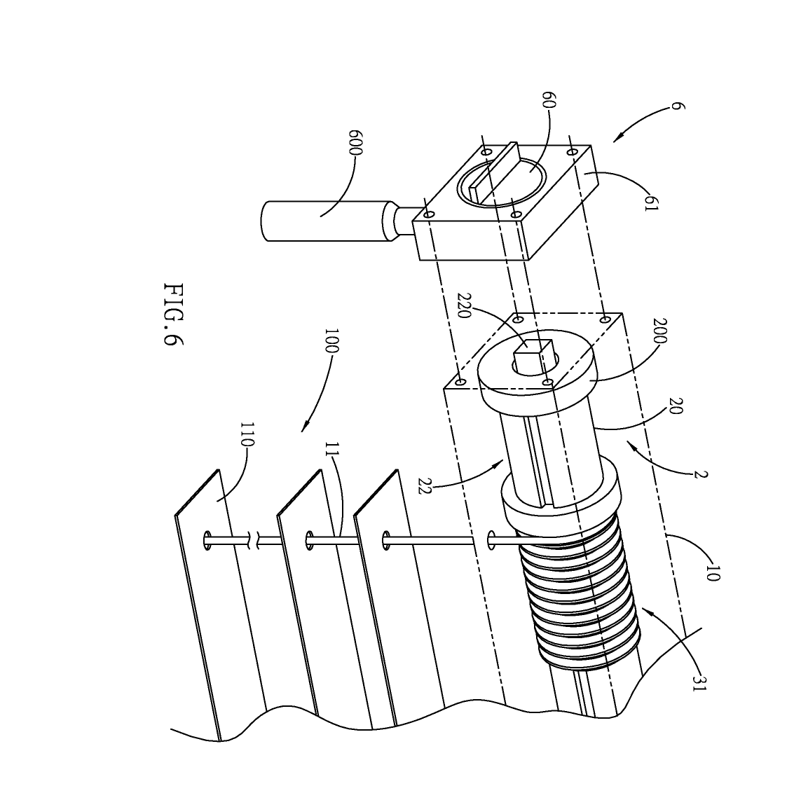

Referring to FIG. 4 and FIG. 5, a position-changing mechanism 4, according to the present invention, is used as a device for adjusting and fixing a shading angle of the pulled-down lath 100. A working center of the position-changing mechanism 4 is principally the same as the working axis S and the position-changing mechanism 4 is across the outer circumference of the shaft tube 20 or the roller 31, forming combination ends 401, 402 at a left and right end. The combination ends 401, 402 provide for connection of ladder cords 111, 112 at a front and rear side of the lath 100. Therefore, a flexible four-bar mechanism is formed by the combination ends 401, 402, the ladder cords 111, 112 and the lath 100. A horizontal angle θ of the combination ends 401, 402 will be changed by altering the lowest lath 100.

Referring to FIG. 6, the present invention utilizes the feedback device 2 as the power for rolling up the laths 100 and the feedback energy of the feedback device 2 must finally be able to pull up the lowest lath 100 to the top end. Some part of the feedback energy of the feedback device 2 should be left behind to tightly pull the lath 100 at the upper end and keep the lath 100 from falling down. The reason of the abovementioned falling-down is also caused by the elastic fatigue after a long time of use.

During the production of the Venetian blind 1 in a factory, the upper end of the lath 100 is combined at the shaft tube 20 in advance and the shaft tube 20 is interconnected with the feedback device 2. After the laths 100 have been rolled up completely and restored, the fixing end of the body of the feedback device 2 is then locked with the corresponding end of the headrail 10. When the feedback device 2 is elastically fatigued after a long time of use, the bottom of the lath 100 will droop by its dead-weight.

To provide an adjustment method for restoring from the drooping of the lath 100 due to elastic fatigue or weight, such that the bottom end of any lath 100 can be completely collected at the topmost end, the present invention is designed with an adjustment device 6 to increase the feedback energy; the adjustment device 6 is configured to increase the elastic energy of the feedback device 2.

The adjustment device 6 includes a connector 61 which is combined at one end of the headrail 10 and operates to the feedback device 2. A center of the connector 61 is provided with a drive disc 60 and a center of the drive disc 60 links to a shaft end 220 of the pivot 22. The drive disc 60 is driven by an adjustment button 600 which is operated manually. Through the operation of the adjustment button 600, the residual of feedback energy of the feedback device 2 can be increased. If the residual of feedback energy is depleted by the feedback device 2 the lath 100 is rolled up completely and can be pulled down and droop without being able to be collected by only exerting a little force to the lower end of the lath 100, then the adjustment button 600 can be operated to change an angle of the shaft end 220 (the direction of adjusting the angle of the shaft end 220 is the same as the direction of feedback motion). Through the adjustment, the feedback device 2 can acquire more residual of feedback energy and the lath 100 can be rolled up completely when the residual of feedback energy is full.

As for the abovementioned design, the present invention implements a proposal as shown in FIG. 6. The adjustment device 6 is combined at one end of the headrail 10 and coaxially links to and fixes a radial angle of the feedback device 2. The shaft end 220 that is extended from the pivot 22 is locked and gnawed with a pier slot 62 of the drive disc 60 of the adjustment device 6. An outer circumference of the drive disc 60 is formed with a worm gear 64 which rotates by a worm 65. The worm 65 is protruded out of the adjustment device 6 and is connected with the adjustment button 600 for adjustment and operation by the user. The worm 65 is positioned, by a shoulder ring 650, inside the adjustment device 6 and can be gnawed with the worm gear 64. Using a limitation to a sliding rate of the worm gear 64 and the worm 65, we can easily adjust an angle of the drive disc 60 to increase the feedback energy of the feedback device 2; whereas, the feedback device 2 operates reversely the worm 65 through the worm gear 64, resulting in a great resistant force, so that the angle of the shaft end 220 can be fixed after adjustment.

Using the link and adjustment of the adjustment device 6, the configuration of the complete roll-up of the laths 100 of various masses can be maintained freely during production or usage, and the feedback device 2 of a single specification can be expanded to be applied to the laths 100 of different masses, as long as that the feedback energy can be complied with.

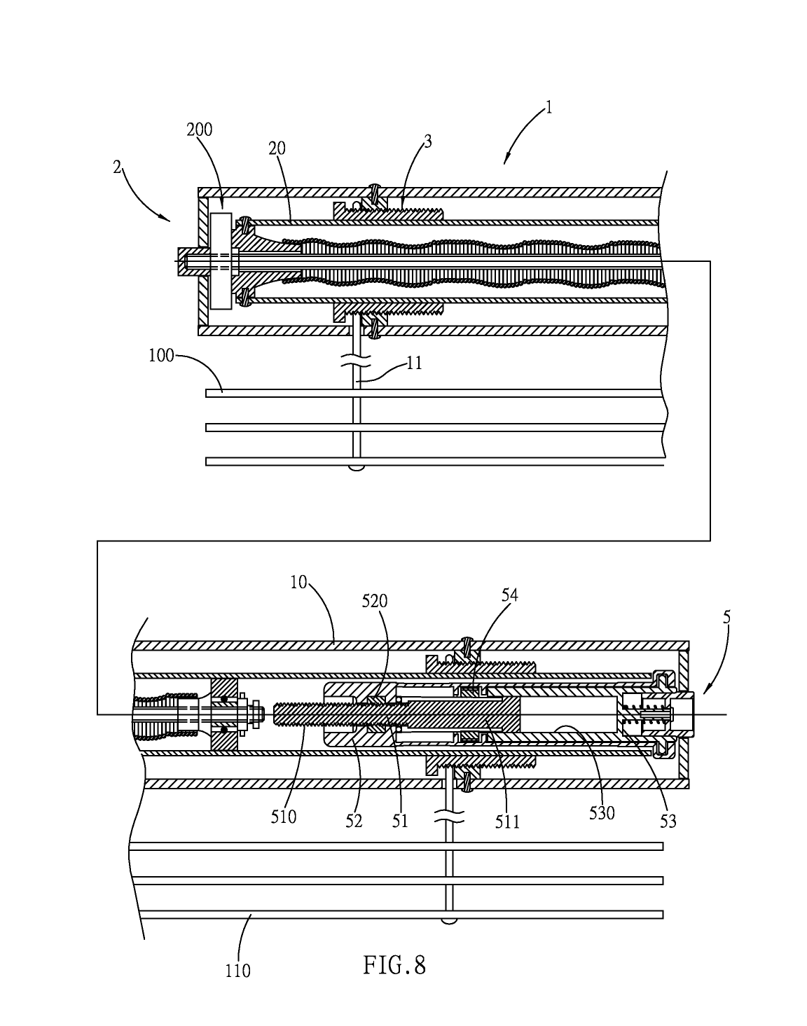

Referring to FIG. 8, as the feedback energy of the feedback device 2 inside the Venetian blind 1 of the present invention can be increased, and the great energy can be stored potentially, the initial feedback energy becomes larger. In addition, the mass of slat is constant; therefore, in the beginning when the slat 100 is to be opened, the feedback energy will become the largest. Accordingly, to moderate the initial feedback power, the present invention is further provided with a design of moderation when the feedback energy is the largest, wherein an interior at the other end of the shaft tube 20 is provided with an axial-type buffering device 5. The buffering device 5 is provided with a fixing end and a working end. The fixing end is combined at a corresponding side of the headrail 10 through a fixing barrel 53. An interior of the fixing barrel 53 is provided with a longitudinal slide rail 530 to provide for longitudinal sliding of a corresponding end of a passive bolt 51. The other end of the passive bolt 51 is cut at by male threads 520 which are provided on an inner circumference of a link barrel 52. The link barrel 52 links the shaft tube 20 to form the working end. Therefore, when the shaft tube 20 rotates, it will drive simultaneously the link barrel 52 to rotate. The male threads 520 of the link barrel 52 cut tangentially the threads 510 of the passive bolt 51, and the other end of the passive bolt 51 is radially limited by the slide rail 530. Hence, the passive bolt 51 will not rotate. However, the threads 510 are operated by the link barrel 52 and therefore, the passive bolt 51 will result in axial displacement toward left or right, due to slant sliding. During displacing toward left or right, a cone unit 511 with a tapered edge is utilized to change an outer diameter of an expansion ring 54 which is provided with an elastic and friction function. The change of that outer diameter will allow the expansion ring 54 to rub on a corresponding surface of an inner circumference of the link barrel 52, forming a damping by the rubbing. Therefore, a rotation speed of the link barrel 52 is restricted. Accordingly, using the buffering device 5, the rotation speed of the shaft tube 20 will be affected and the time of that interference is when the stored energy of the feedback device 2 is the largest, where the largest damping interference to the rotation of the shaft tube 20 can be resulted by the buffering device 5. On the contrary, when the stored energy of the feedback device 2 is released and weakened, as the escape of the cone unit 511, the compression to the expansion ring 54 by the buffering device 5 will be lost gradually. Hence, the interference to the inner circumference of the shaft tube 20 by the outer circumference of the expansion ring 54 will be diminished gradually. By the alternate and progressive relation of the friction damping between the shaft tube 20 and the expansion ring 54, the lath 100 can be rolled up at an even more uniform speed.

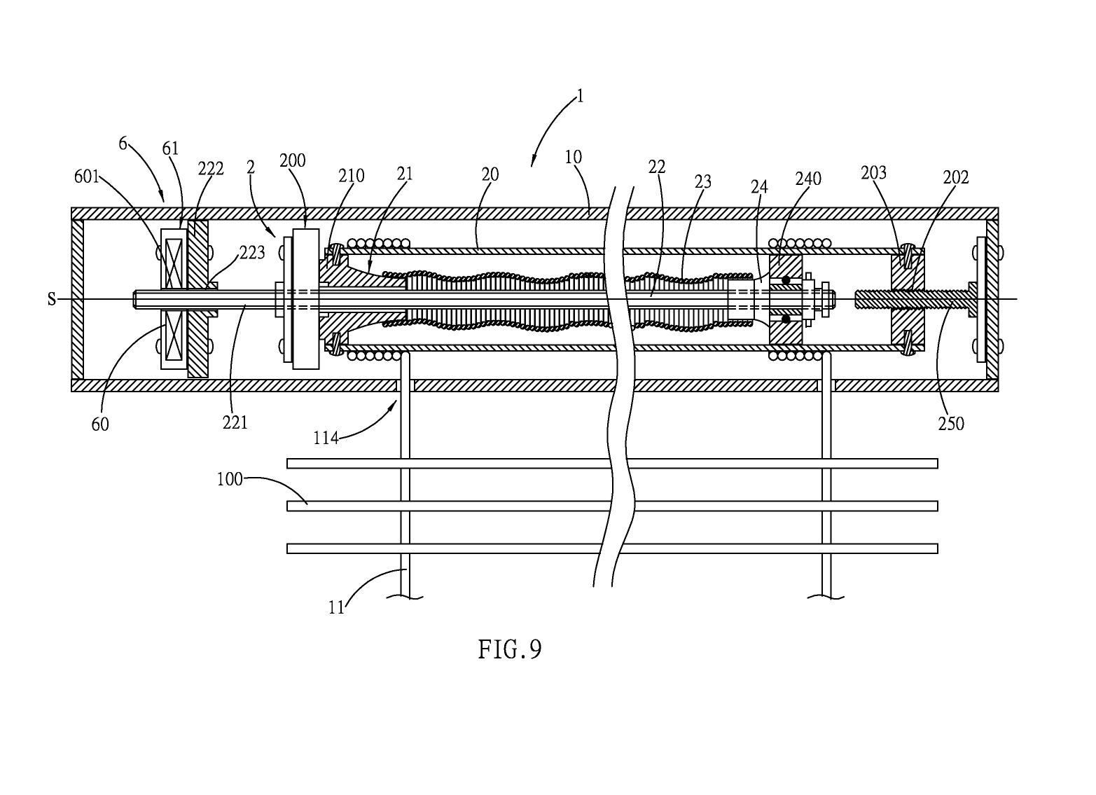

Referring to FIG. 9, the present invention further provides a design which uses the outer circumference of the shaft tube 20 to directly wind the lift cords 11, without using the abovementioned winding device 3. In addition to having more simplified elements, the total frictional force when multiple elements are operating can be removed. Besides, during the process of rolling up and down the lift cords 11, the shaft tube 20 can have the dual-functional effect of rolling and displacing axially, allowing the lift cords 11 that are wound at the outer circumference of the shaft tube 20 to be arranged orderly.

As for the design of rolling up the lift cords directly by the shaft tube 20, an end (right end) of the shaft tube 20 is primarily guided by a bolt 250 and a left end of the shaft tube 20 is extended with a slide bar 221 from the pivot 22 of the feedback device 2. The slide bar 221 passes through an inner hole 223 in a center of a fixing plate 222 inside the headrail 10 and is transfixed at a sliding port 601 of the adjustment device 6. The adjustment device 6 is fixed at one side of the fixing plate 222 and a center of the radial limiting mechanism 200 is also limited radially by the slide bar 221. An upper end of the lift cord 11 is combined on a surface of the shaft tube 20; whereas, a lower end is linked with the lath 100. The pier 21 of the feedback device 2 is coaxially assembled with the radial limiting mechanism 200 and moves relatively to the radial limiting mechanism 200. When the lath 100 is pulled down to move the lift cord 11 downward, the lift cord 11 will compress and rub the shaft tube 20; whereas, a passive force of the shaft tube 20 will be transmitted to the volute spring 23 through the pier 21. As the other end of the volute spring 23 is fixed by the support element 24, the passive force will act onto the volute spring 23, allowing the volute spring 23 to be distorted and deformed to result in the feedback energy. When the lift cord 11 is pulled down and stops at a height, including that the lath 100 drops to the bottommost position, the link ring 210 which is coaxially assembled with the pier 21 will be fixed radially by the radial limiting mechanism 200. Therefore, the feedback energy which is formed by pulling down the lift cord 11 will be stored inside the volute spring 23 and the power of recollecting the lath 100 can be provided by the stored feedback energy.

When the abovementioned lift cord 11 is pulled down or rolled back and when the shaft tube 20 is rotating, the right end of the shaft tube 20 is guided by the bolt 250 which is fixed at the right end of the headrail 10 to result in an axial displacement. The right end of the shaft tube 20 is provided with an end sealing element 203, a center of which is provided with inner threads 202 corresponding to outer threads of the bolt 250. As the end sealing element 203 is combined as a same unit with the shaft tube 20 and the bolt 250 is fixed without moving, when the shaft tube 20 is rotating, the inner threads 202 will be driven to cut tangentially at the bolt 250, allowing the bolt 250 to advance by a stroke and the shaft tube 20 to result in an axial displacement. The scale (distance of threads) of the movement is that every turn of the movement is the same as a diameter of the lift cord 11. Therefore, the lift cord 11 that is wound at the outer circumference of the shaft tube 20 can be arranged orderly and the part of the lift cord 11 that droops can be aligned at the center position of a port 114.

The other end of the shaft tube 20 is combined with the feedback device 2 which moves relatively to and is assembled as a same unit with the radial limiting mechanism 200. The radial limiting mechanism 200 and the shaft tube 20 move axially at a same time, but the radial limiting mechanism 200 is radially combined with the slide bar 221 and is therefore restricted. A body part of the slide bar 221 is sliding in the inner hole 223 of the fixing plate 222 and the entire axis of the shaft tube 20 can be overlapped with the working axis S.

In the present invention, the outer end of the fixing plate 222 is combined with the adjustment device 6. In this embodiment, there is no interruption between the inner hole 223 of the fixing plate 222 and the slide bar 221 by expanding the inner diameter of the inner hole 223 and making the inner hole 223 a round hole. On the other hand, the angle of the slide bar 221 is limited by the adjustment device 6.

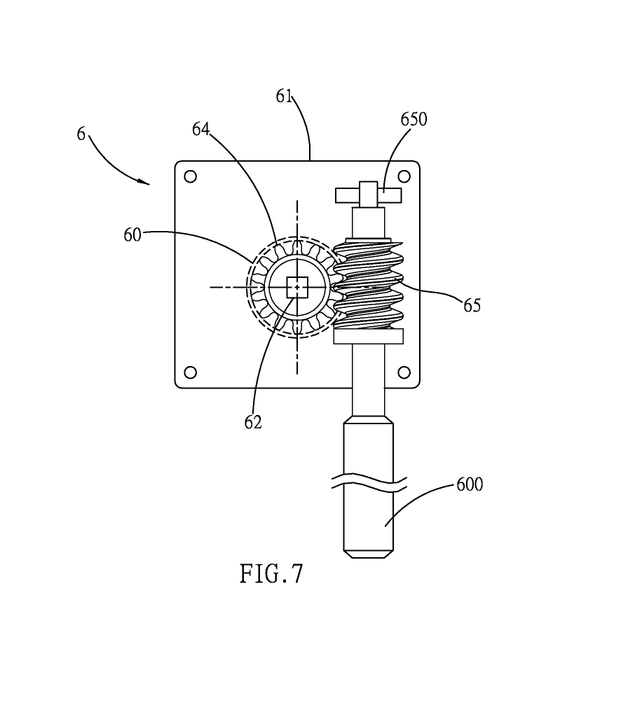

The adjustment device 6 is similarly provided with the connector 61 which is combined at the fixing plate 222. However, the center of the drive disc 60 of the connector 61 is provided with the sliding port 601 which can provide for axial sliding of the slide bar 221, but can interfere with the radial rotation of the slide bar 221. Therefore, the disk drive 60, as shown in FIG. 7, can drive the pivot 22 indirectly to increase or decrease the feedback energy.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automatic roll-up device of a Venetian blind, being used in a blind without lift cords and capable of rolling up by itself, comprising:
a headrail which links downward laths through lift cords;
an axial feedback device which is provided at one end in a longitudinal space inside the headrail and includes a volute spring, with that one end of the volute spring is combined with a pier, the other end of the volute spring is combined with a support element, the support element is fixed by and combined with an opposite end of a pivot that is pivoted in a hollow passage of the volute spring, the other end of the pivot passes through a shaft hole of the pier and is fixed at an opposite end of the headrail, whereas the pivot moves radially with respect to the pier;
a radial limiting mechanism that operates centrifugally and is fixed inside the headrail, at an outer end facing a link ring extended from the pier, with that the radial limiting mechanism achieves interconnection with the link ring, further limit and define a radial angle of the link ring;
a shaft tube, an end of an inner circumference of which is combined at an outer circumference of the link ring of the pier, the other end of the inner circumference is movably pivoted at a pivot seat provided at an opposite end of the headrail, and a longitudinal slot penetrates an outer circumference of the shaft tube along an axial direction;
at least one winding device, which includes a roller for winding the lift cord, an inner circumference of the roller is provided with a slide block in the longitudinal slot, and an outer circumference of the roller is provided with threads having a distance of threads the same as a diameter of the lift cord, with that a root portion of the threads is combined at an upper end of the lift cord, an inner circumference of the roller is movably sheathed on an outer circumference of the shaft tube and is linked by the shaft tube; and
at least one rotary-cut element corresponding to the winding device, with that the rotary-cut element is combined inside the headrail at a location corresponding to the winding device and an inner circumference of the rotary-cut element is provided with female threads providing for cutting tangentially of the threads of the roller.

2. The automatic roll-up device of a Venetian blind according to claim 1, wherein an outer circumference of the support element which is combined with the pivot is movably assembled with an inner circumference of an opposite end of the shaft tube through an annular unit, allowing an axis of the pivot to be overlapped with a working axis.

3. The automatic roll-up device of a Venetian blind according to claim 1, wherein an interior of the shaft tube is installed with an axial-type buffering device at a space yielded by the support element, with that the buffering device includes a link barrel, an outer circumference of the link barrel is combined at the inner circumference of the shaft tube, and an inner circumference of the link barrel is movably pivoted with a fixing barrel, with that an end of the fixing barrel is fixedly combined at a corresponding side of the headrail, an inner circumference of the fixing barrel is axially provided with a slide rail for axial sliding of a corresponding end of a passive bolt, the other end of the passive bolt is provided with threads which cut tangentially at male threads at corresponding positions on the inner circumference of the link barrel, the body portion of the passive bolt is provided with a cone unit, a tapered circumference of the cone unit operates an inner circumference of an expansion ring which is limited longitudinally, and an outer circumference of the expansion ring results in a friction action to operate on the inner circumference of the link barrel, after the inner circumference of the expansion ring has been expanded.

4. The automatic roll-up device of a Venetian blind according to claim 1, wherein the pivot provided by the feedback device is extended outward with a shaft end which is locked by a drive disc of an adjustment device that an angle of the shaft end is altered by the adjustment device and the shaft end is positioned.

5. The automatic roll-up device of a Venetian blind according to claim 4, wherein the adjustment device is provided with a connector which is combined at an end of the headrail, with that an interior of the connector is provided with a drive disc, a center of the drive disc is provided with a pier for locking with the shaft end of the pivot, the drive disc is driven through an external adjustment button, and an outer circumference of the drive disc is provided with a ratchet which is engaged by a pawl moving inside the connector to restrict a positioning angle of the shaft end.

6. An automatic roll-up device of a Venetian blind, comprising:
a headrail, a lower end of the headrail drops laths through lift cords, an end of the headrail is provided with a fixing plate, and the other end of the headrail is combined axially with an inward bolt, with that a center of the fixing plate is provided with an inner hole;
a feedback device which is provided with a pier and a support element, with that the two elements provide respectively for combination of two end ports of a volute spring, an end of a pivot which is pivoted in a hollow passage of the volute spring is fixed and assembled with the support element, the other end of the pivot is extended with a slide bar, the slide bar is radially restricted by the inner hole of the fixing plate and slides axially in the inner hole of the fixing plate, and the pier moves axially and radially with respect to the pivot;
a radial limiting mechanism that operates centrifugally, a center of the radial limiting mechanism is fixed and combined with the pivot and is assembled coaxially with the link ring extended from the pier to interfere and release limitation of a radial angle to the link ring; and
a shaft tube, an interior of the shaft tube provides for pivoting of the feedback device, an end of the shaft tube is coaxially combined at an outer circumference of the link ring of the pier, a center at the other end of the shaft tube forms inner threads which cut tangentially at outer threads of the axially inward bolt that is fixed, and an outer circumference of the shaft tube provides for combination of an upper end of any lift cord.
